(19) United States
(12) Patent Application Publication
(10) Pub. No.: US 2013/0187353 A1
(43) Pub. Date: Jul. 25, 2013

(54) MULTI-BRAKE SYSTEM HAVING INDEPENDENT CONTROL

(71) Applicants: Erwin Mock, Springfield, IL (US); John J. Kaufman, Yorkville, IL (US); Dylan C. Hayden, Edelstein, IL (US); Scott D. Vollmer, Naperville, IL (US)

(72) Inventors: Erwin Mock, Springfield, IL (US); John J. Kaufman, Yorkville, IL (US); Dylan C. Hayden, Edelstein, IL (US); Scott D. Vollmer, Naperville, IL (US)

(21) Appl. No.: 13/355,944

(22) Filed: Jan. 23, 2012

(51) Int. Cl. B60T 13/64; E02F 3/00; B60T 7/02

(52) U.S. Cl. 280/80.1; 701/70; 303/9.61

(57) ABSTRACT

A brake system for a mobile machine is disclosed. The brake system may have a first brake associated with a first traction device of the mobile machine, and a second brake associated with a second traction device of the mobile machine. The brake system may also have an operator input device movable through a range from a neutral position to a maximum displaced position to generate a signal indicative of a desire to brake the mobile machine, and a controller in communication with the operator input device. The controller may be configured to activate only the first brake based on the signal when the operator input device has been displaced to a position less than a threshold position within the range, and to activate both the first and second brakes based on the signal when the operator input device has been displaced to a position greater than the threshold position.

### TECHNICAL FIELD

The present disclosure relates to a brake system and, more particularly, to a multi-brake system having independent control.

### BACKGROUND

Most mobile machines are equipped with some kind of brake system that can be used to slow the machines in response to operator input. Typical brake systems can include one or more dry brakes or one or more wet brakes associated with different axles and/or wheels of the machine. A dry brake generally includes a reaction plate, a pressure plate, one or more friction plates sandwiched between the reaction and pressure plates (sometimes separated by spacer plates), and a biaser that urges the pressure plate toward the reaction plate. The reaction and pressure plates are both connected to and supported by a stationary housing, while the friction plate(s) are rotationally fixed to rotate with and be supported by the axle or wheel of the mobile machine. In this arrangement, the biaser, via the reaction and pressure plates, generates and applies a pressure on the friction plate(s) to retard the motion of the associated axle or wheel. A wet brake is substantially identical to the dry brake, but is also generally submerged in a stagnant or circulating oil bath that cools the brake during operation. The dry brake is simple, inexpensive, and easy to service, but also wears faster and has a lower braking capacity than the wet brake due to extreme temperatures experienced by the dry brake.

During operation, in response to an operator displacing a brake pedal or other input device, brakes located at each axle or wheel of a mobile machine are activated by about the same amount. That is, most brakes are hydraulically actuated by applying a fluid pressure to the biaser of each brake, the pressure being substantially proportional to the displacement position of the brake pedal. Because of the momentum of a moving machine traveling in a forward direction the machine's weight may be unequally distributed to the brakes located at the front axles, causing these brakes tend to perform a greater percentage of the overall braking. For this reason, the front-located brakes tend to heat more and wear faster than rear-located brakes.

An exemplary brake system having wet brakes is disclosed in U.S. Pat. No. 8,006,813 issued to James et al. on Aug. 30, 2011 (“the '813 patent”). Specifically, the '813 patent discloses a system having a wet brake arrangement associated with a drive axle of a machine, a heat exchanger that uses engine coolant to cool an oil bath in the wet brake arrangement, a temperature sensor positioned near the heat exchanger, and a controller that is configured to regulate operation of a coolant valve in response to signals from the temperature sensor to manage a temperature of the wet brake arrangement and thereby extend a life of the wet brake arrangement.

While the system of the '813 patent may provide for desired braking of a mobile machine and longevity of the system through temperature control of a wet brake, the system may still be less than optimal. In particular, the system, when applied to multiple axles of a machine, may be overly complex, expensive, and difficult to service.

The present disclosure is directed to overcoming one or more of the problems set forth above and/or other problems of the prior art.

### SUMMARY

In one aspect, the present disclosure is directed to a brake system for a mobile machine. The brake system may include a first brake associated with a first traction device of the mobile machine, and a second brake associated with a second traction device of the mobile machine. The brake system may also include an operator input device movable through a range from a neutral position to a maximum displaced position to generate a signal indicative of a desire to brake the mobile machine, and a controller in communication with the operator input device. The controller may be configured to activate only the first brake based on the signal when the operator input device has been displaced to a position less than a threshold position within the range, and to activate both the first and second brakes based on the signal when the operator input device has been displaced to a position greater than the threshold position.

In another aspect, the present disclosure is directed to a method of braking a mobile machine. The method may include receiving an operator generated signal indicative of a desire to brake the mobile machine. The method may also include activating only a first brake when the signal has a value less than a threshold value, and activating the first brake and a second brake when the signal has a value greater than the threshold value.

### BRIEF DESCRIPTION OF THE DRAWINGS

FIG. 1 is a pictorial illustration of an exemplary disclosed machine;

FIG. 2 is a diagrammatic illustration of an exemplary disclosed brake system that may be used with the machine of FIG. 1; and

FIG. 3 is a flowchart depicting an exemplary disclosed method of operating the brake system of FIG. 2.

### DETAILED DESCRIPTION

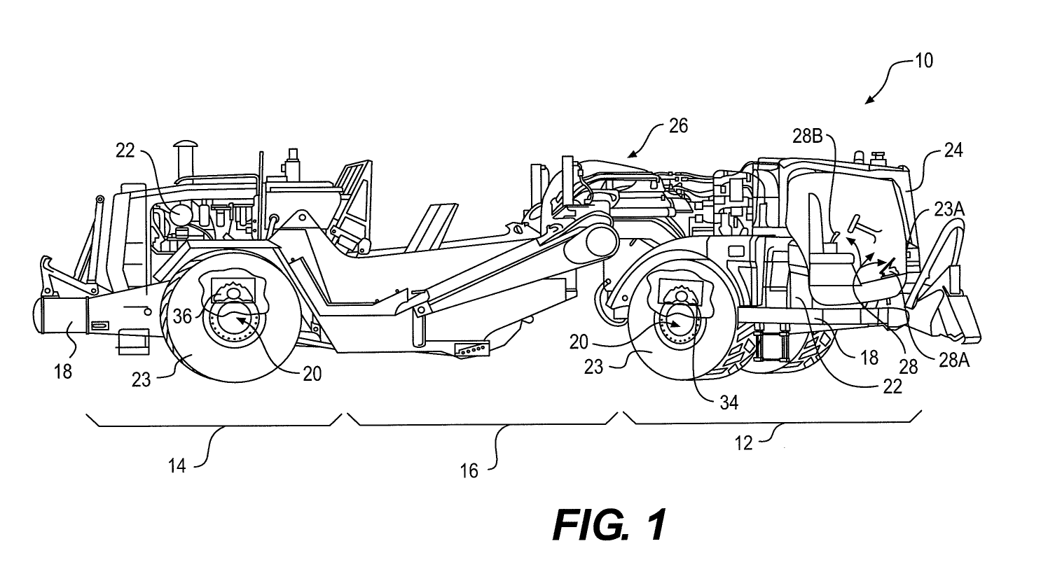

FIG. 1 illustrates an exemplary mobile machine 10. Machine 10, in the disclosed example, is an earth-moving machine such as scraper configured to load material at a first location, transport the material from the first location to a second location, and unload the material at the second location. It is contemplated, however, that machine 10 may embody another type of mobile machine, if desired, such as an on- or off-highway haul truck, a wheel loader, or another machine. Machine 10 may include a front tractor 12 operatively connected to a rear tractor 14. Front and rear tractors 12, 14 may cooperate to pull and push a bowl 16 across a ground surface, respectively.

Each of front and rear tractors 12, 14 may include multiple components that interact to power and control operations of machine 10. Specifically, each of front and rear tractors 12, 14 may include a frame 18, an axle assembly 20, and a power source 22. Frame 18 of front tractor 12 may be supported by the front-located axle assembly 20 and, in turn, support an operator station 24. Frame 18 of rear tractor 14 may likewise be supported by the rear-located axle assembly 20 and, in turn, rigidly support bowl 16. Front tractor 12 may be connected to a leading end of bowl 16 by way of an articulated hitch assembly 26. Power sources 22 may include, for example, combustion engines that drive front and rear axle assemblies 20 to rotate front and rear traction devices 23 (e.g., wheels, tracks, belts, etc.), respectively, and that provide electrical and hydraulic power to the various components of machine 10. Operator station 24, as will be described in more detail below, may facilitate manual control of machine 10.

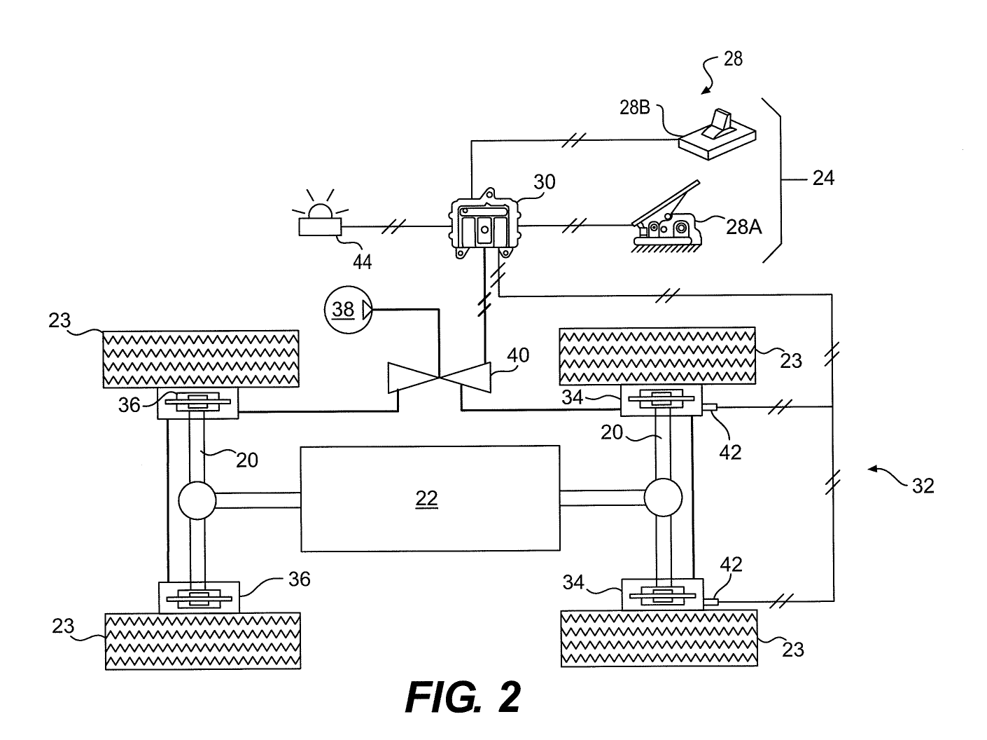

Operator station 24 may include one or more operator input devices 28 located proximate an operator seat and configured to generate control signals associated with desired braking operations of machine 10. For example, a first operator input device 28A is shown as a pedal that is movable from a neutral position through a range to a maximum displaced position to generate a corresponding braking signal indicative of a desired amount of braking. The braking signal may have a value substantially proportional to the displacement position of first operator input device 28A. A second operator input device 28B is shown as a switch that is selectively manipulated by an operator of machine 10 to generate a corresponding braking mode signal. The mode signal may have a first value when second operator input device 28B is in a first position, and a second value when second operator input device is in a second position. The signals generated by first and second operator input devices 28A, 28B may be directed to a controller 30 (referring to FIG. 2) for further processing. It is contemplated that operator input devices 28 may be devices other than a pedal and a switch, if desired, for example a joystick, a lever, a handle, a push button, a wheel, or any other device known in the art.

As shown in FIG. 2, machine 10 may be equipped with a brake system 32 that includes components that cooperate to decelerate machine 10 in response to input received via operator station 24. In particular, brake system 32 may include, among other things, operator input devices 28, controller 30, one or more first brakes 34 associated with the front-located axle assembly 20, and one or more second brakes 36 associated with the rear-located axle assembly 20. Although the exemplary brake system 32 shown in FIG. 2 includes one brake located at each traction device 23 (i.e., two brakes per axle assembly 20), it is contemplated that a single brake may be associated with each of axle assemblies 20, if desired.

First and second brakes 34, 36 may be different types of brakes. For example, first brakes 34 may be wet brakes, while second brakes 36 may be dry brakes. Each of first and second brakes 34, 36 may generally include a reaction plate, a pressure plate, one or more friction plates sandwiched between the reaction and pressure plates (separated by spacer plates, if desired), and a biaser that urges the pressure plate toward the reaction plate. The reaction and pressure plates may both be connected to and supported by a stationary housing, while the friction plate(s) may be rotationally fixed to rotate with and be supported by traction devices 23. In this arrangement, the biaser, via the reaction and pressure plates, may generate and apply a pressure on the friction plate(s) to retard the motion of the associated traction device. First brakes 34, unlike second brakes 36, may additionally be at least partially submerged in a stagnant or circulating oil bath that cools the various components during operation.

In the disclosed exemplary embodiment, first and second brakes 34, 36 may be hydraulically activated. In particular, brake system 32 may include a source of pressurized fluid, for example an engine-driven pump 38. Pump 38 may pressurize fluid and direct the pressurized fluid through a control valve 40 to first and second brakes 34, 36. Depending on a position of control valve 40, only first brakes 34 may be activated, only second brakes 36 may be activated, or both first and second brakes 34, 36 may be simultaneously activated. In addition, depending on the position of control valve 40 and/or an adjustable parameter of pump 38, a pressure of the fluid directed to first and/or second brakes 34, 36, may be varied, thereby varying an actuation degree of the corresponding devices.

Control valve 40 may be any type of valve known in the art, for example a pilot activated valve, a solenoid activated valve, a pneumatic valve, a single stage valve, a multi-stage valve, a single spool or poppet valve, or a combination of multiple spools and/or poppets. Operation of control valve 40 may be regulated by controller 30 in response to signal received from first and second operator input devices 28A, 28B and/or in response to one or more signals received from a temperature sensor 42, as will be described in more detail below.

In an exemplary embodiment, temperature sensor 42 may be associated with only first brakes 34 and configured to generate a signal indicative of a temperature of first brakes 34. In the disclosed embodiment, temperature sensor 42 may embody a thermocouple disposed within a housing of first brakes 34, and the signal generated by temperature sensor 42 may be indicative of a temperature of fluid within a housing of first brakes 34. It is contemplated, however, that a different type of temperature sensor located in the same or another location may alternatively be utilized by controller 30, if desired. Additionally, temperature sensors may also be associated with second brakes 36 in a manner similar to first brakes 34, if desired.

Controller 30 may be configured to receive signals from operator input devices 28 and temperature sensor 42, and execute instructions stored on a computer readable medium to perform a method of braking control in response to the signals. Controller 30 may include any component or combination of components for monitoring, recording, storing, indexing, processing, and/or communicating operational aspects of machine 10 described above. These components may include, for example, a memory, one or more data storage devices, a central processing unit, or any other components that may be used to run an application. Furthermore, although aspects of the present disclosure may be described generally as being stored in memory, one skilled in the art will appreciate that these aspects can be stored on or read from types of computer program products or computer-readable media, such as computer chips and secondary storage devices, including hard disks, floppy disks, optical media, CD-ROM, or other forms of RAM or ROM. Controller 30 may execute sequences of computer program instructions stored on the computer readable media to perform methods of braking control that will be explained below.

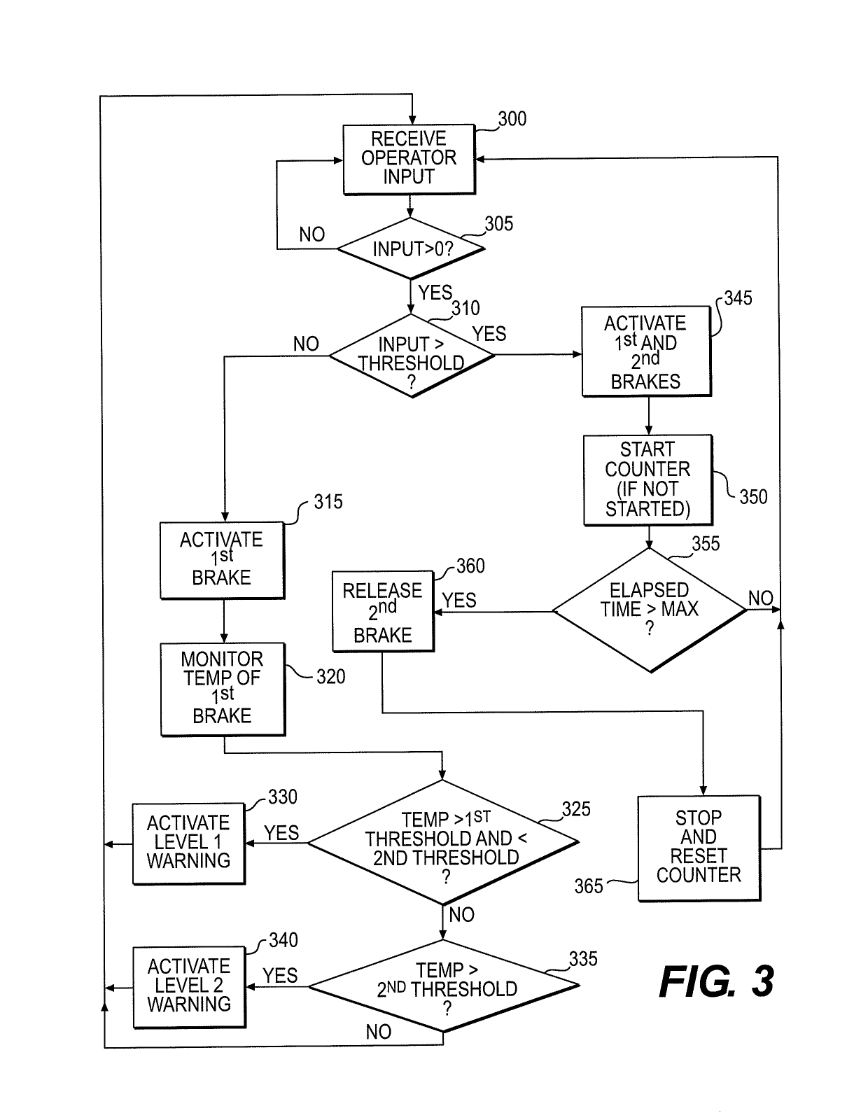

FIG. 3 illustrates an exemplary method stored as instructions on the computer readable medium that are executable by controller 30 to perform braking control of machine 10. FIG. 3 will be discussed in more detail in the following section to further illustrate the disclosed concepts.

### INDUSTRIAL APPLICABILITY

The disclosed brake system may be applicable to any mobile machine where longevity of braking components in a simple, low-cost, easy-to-service solution is desired. The disclosed brake system may provide for these needs through the selective and independent use of both wet brakes and dry brakes based on sensed temperatures and operator input. Operation of brake system 32 will now be explained with respect to FIG. 3.

The exemplary method of braking machine 10 may begin with controller 30 receiving input from the operator of machine 10 regarding desired braking (Step 300). As described above, the input may include, among other things, a braking signal corresponding to a displacement position of first operator input device 28A and a mode signal corresponding to a position of second operator input device 28B. Controller 30 may determine if the braking signal from first operator input device 28A indicates a displacement position away from neutral (e.g., if the signal has a value greater than about zero), and respond accordingly (Step 305). When first operator input device 28A is in its neutral position, the braking signal may be about zero and controller 30 may not activate first or second brakes 34, 36 such that machine 10 is not intentionally decelerated. However, when first operator input device 28A is in a displaced position (i.e., away from neutral), controller 30 may determine whether the displaced position is less than or greater than a threshold position (Step 310). In the disclosed embodiment, the threshold position may be about 20-35% of the range from the neutral position toward the maximum displaced position.

When first operator input device 28A is moved away from the neutral position to a displaced position less than the threshold position (Step 310: No), controller 30 may determine that the operator desires a relatively low level of braking and, accordingly activate only first brakes 34 to a corresponding degree (Step 315). As described above, first brakes 34 may be selectively activated by controller 30 causing movement of control valve 40 to a particular position at which pressurized fluid from pump 38 passes through control valve 40 to only first brakes 34 at a pressure corresponding to the displacement position of first operator input device 28A and/or to an adjustable setting of pump 38. During operation of first brakes 34, controller 30 may monitor the temperature of first brakes 34 via temperature sensors 42 (Step 320). Because a majority of braking operations involve only low-levels of braking, first brakes 34, which may be more durable than second brakes 36, may be used alone a majority of the time.

If during the operation of first brakes 34, controller 30 detects via temperature sensor 42 an elevated temperature, for example elevated above a first threshold temperature, controller 30 may activate a warning. For example when controller 30 detects the temperature of first brakes 34 rising above a first threshold temperature, but remaining below a second higher threshold temperature (Step 325), controller 30 may activate a level one warning (Step 330). In the disclosed embodiment, the level one warning may include, for example, illumination of a warning lamp 44 located within operator station 24. The first threshold temperature, in this example, may be about 110° C., which may be a temperature beyond which damage to first brakes 34 is likely to occur. Controller 30 may continue to monitor the temperature of first brakes 34 during operation and, when controller 30 determines that the temperature has risen above the second threshold temperature (Step 335), controller 30 may activate a level two warning (Step 340). In the disclosed embodiment, the level two warning may include, for example, illumination of the warning lamp (e.g., in a different color than illuminated during the level one warning) and logging of a fault condition. The second threshold temperature, in this example, may be about 120° C., which may be a temperature at which damage to first brake 34 has likely already occurred. After activation of level one and/or level two warnings, control may return to step 300. Similarly, as long as temperatures remain below the first and second threshold temperatures, control may return from step 335 to step 300.

Returning to step 310, when first operator input device 28A is moved away from the neutral position to a displacement position greater than the threshold position (Step 310: Yes), controller 30 may determine that the operator desires a relatively high level of braking and, accordingly simultaneously activate first and second brakes 34, 36 to corresponding degrees (Step 345). It is contemplated that, during simultaneous brake activation, first brakes 34 may be activated to the same or to a different degree as second brakes 36, as desired. Once second brake 36 have been activated, controller 30 may start counting a time elapsed since activation (Step 350).

Controller 30 may track an amount of time elapsed since activation of second brakes 36 to help ensure that second brakes 36 are not over-utilized. In particular, because second brakes 36 may be dry brakes and not cooled in the same manner as wet brakes, second brakes 36 may heat up much more rapidly and to higher temperatures. Accordingly, controller 30 may track the amount of time elapsed since activation of second brakes 36 and compare the elapsed time to a maximum allowable time of activation (Step 355). The maximum allowable time of activation may correspond with an expected maximum allowable temperature of second brakes 36 that results in a desired longevity of second brakes 36. In the disclosed exemplary embodiment, the maximum allowable time may be about 3 seconds and correspond with about 110° C. When, at step 355, controller 30 determines that the maximum allowable time has elapsed since activation of second brakes 36, controller 30 may release or deactivate second brakes 36 (Step 360) and stop and reset the counting of elapsed time (Step 365). In some embodiments, second brakes 36 must remain deactivated for a minimum amount of time, for example about one second, between activation periods to allow second brakes 36 adequate time to cool before reuse. Following step 365, control may return to step 300. If at step 355, however, controller 30 determines that the elapsed period of time has not yet exceeded the maximum allowable time, control may return directly to step 300 without stopping and resetting the counting of elapsed time.

In some embodiments, the operator may be allowed to override controller 30 at any time during activation of first and/or second brakes 34, 36. In particular, the operator may be able to manually choose to disable or otherwise turn off second brakes 36 via second input device 28B. The operator may choose to disable second brakes 36 in response to a warning from controller 30, based on knowledge of the integrity of second brakes 36 (e.g., based on a known need to service second brakes 36), or based on any other factor or parameter known in the art. Accordingly, controller 30 may operate second brakes 36 normally when the mode signal received from second operator input device 28B has the first value, and selectively turn off second brakes 36 when the mode signal has the second value.

Because brake system 32 may utilize both wet brakes and dry brakes, brake system 32 may include advantages associated with both types of brakes. In particular, first brakes 34, being wet brakes and utilized more often than second brakes 36, may extend a useful life of brake system 32. In addition, because not all of the brakes of brake system 32 are wet brakes (i.e., because second brakes 36 may be dry brakes), brake system 32 may be simpler, less expensive, and easier to service. In addition, dry brakes may have less associated drag than wet brakes.

It will be apparent to those skilled in the art that various modifications and variations can be made to the disclosed brake system. Other embodiments will be apparent to those skilled in the art from consideration of the specification and practice of the disclosed brake system. For example, although the disclosed brake system is described as having front-located wet brakes and rear-located dry brakes, it may be possible for the front-located brakes to alternatively be dry brakes and the rear-located brakes to be wet brakes, if desired. In addition, although the disclosed system is described as affecting brake operation based on elapsed periods of time and/or in response to measured temperatures, it is contemplated that brake operation could alternatively be affected in similar manner based on modeled temperatures, if desired. It is intended that the specification and examples be considered as exemplary only, with a true scope being indicated by the following claims and their equivalents.

What is claimed is:

1. A brake system for a mobile machine, comprising:
a first brake associated with a first traction device of the mobile machine;
a second brake associated with a second traction device of the mobile machine;
an operator input device movable through a range from a neutral position to a maximum displaced position to generate a signal indicative of a desire to brake the mobile machine; and;
a controller in communication with the operator input device and configured to:
activate only the first brake based on the signal when the operator input device has been displaced to a position less than a threshold position within the range; and
activate both the first and second brakes based on the signal when the operator input device has been displaced to a position greater than the threshold position.

2. The brake system of claim 1, wherein the first brake and the second brake are different types of brakes.

3. The brake system of claim 2, wherein the first brake is located at a front axle assembly of the mobile machine and the second brake is located at a rear axle assembly of the mobile machine.

4. The brake system of claim 3, wherein the first brake is a wet brake and the second brake is a dry brake.

5. The brake system of claim 4, wherein the controller is further configured to stop activating the second brake after a threshold period of activation has elapsed, regardless of the position of the operator input device.

6. The brake system of claim 5, wherein the threshold period of activation is about 3 seconds.

7. The brake system of claim 3, wherein the first and second brakes are both hydraulically actuated.

8. The brake system of claim 7, wherein a pressure of fluid supplied to the first and second brakes is substantially proportional to a displacement position of the operator input device.

9. The brake system of claim 3, further including a temperature sensor associated with only the first brake, wherein the controller is further configured to provide a warning to an operator of the mobile machine based on a signal from the temperature sensor.

10. The brake system of claim 9, wherein the warning has a first level associated with a first threshold temperature, and a second level associated with a second threshold temperature.

11. The brake system of claim 10, wherein:
the first level warning includes illumination of a warning lamp in an operator station of the mobile machine when the signal indicates a temperature of about 110° C.; and
the second level warning includes illumination of the warning lamp and logging of a fault condition when the signal indicates a temperature of about 120° C.

12. The brake system of claim 10, wherein:
illumination of the warning lamp during the first level warning includes illumination of the warning lamp in a first color; and
illumination of the warning lamp during the second level warning includes illumination of the warning lamp in a second color.

13. The brake system of claim 3, wherein the controller is further configured to turn off the second brake in response to operator manipulation of a mode switch.

14. A mobile machine, comprising:
a frame;
an operator station supported by the frame and having at least one input device movable through a range from a neutral position to a maximum displaced position to generate a signal indicative of a desire to brake the mobile machine;
a front traction device configured to support the frame at a front end of the mobile machine;
a rear traction device configured to support the frame at a rear end of the mobile machine;
a wet brake associated with the front traction device;
a dry brake associated with the rear traction device; and
a controller in communication with the at least one input device and configured to:
activate only the wet brake based on the signal when the at least one input device has been displaced to a position less than a threshold amount of the range;
activate both the wet and dry brakes based on the signal when the at least one input device has been displaced to a position greater than the threshold amount of the range; and
stop activating the dry brake after a threshold amount time has elapsed after of activation of the dry brake, regardless of the position of the at least one input device.

15. A method of braking a mobile machine, comprising:
receiving an operator generated signal indicative of a desire to brake the mobile machine;
activating only a first brake when the signal has a value less than a threshold value; and
activating the first brake and a second brake when the signal has a value greater than the threshold value.

16. The method of claim 15, further including stopping activation of the second brake after a threshold period of activation has elapsed, regardless of the value of the signal.

17. The method of claim 16, wherein the threshold period of activation is about 3 seconds.

18. The method of claim 15, wherein the first brake is a wet brake associated with a front traction device, and the second brake is a dry brake associated with a rear traction device.

19. The method of claim 18, further including sensing a temperature of the wet brake and generating a warning based on a sensed temperature.

20. The method of claim 19, wherein generating the warning includes:
generating a first level warning when the sensed temperature exceeds a first threshold temperature; and
generating a second level warning when the sensed temperature exceeds a second threshold temperature.
